(19) United States
(12) Patent Application Publication
(10) Pub. No.: US 2004/0140311 A1
(43) Pub. Date: Jul. 22, 2004

(54) Heat-insulated container

(76) Inventor: Albert Benat, Paris (FR)

Correspondence Address: Law Offices of William H Holt, First Floor Unit 2, 1423 Powhatan Street, Alexandria, VA, 22314, US

(21) Appl. No.: 10/467,865

(22) PCT Filed: Feb. 12, 2002
(86) PCT No.: PCT/FR02/00529

(30) Foreign Application Priority Data
Feb. 13, 2001 (FR) 01/01958

(51) Int. Cl. A47J 41/00

(52) U.S. Cl. 220/592.2

(57) ABSTRACT

The invention concerns a heat-insulated container (1), preferably a bottle, flask, can or the like, designed to receive directly a product, preferably a food product, introduced or extracted through an opening (5) closed with a cap (6) in a chamber (4) delimited by an inner wall, said container further comprising an outer wall (3) which, with the inner wall, defines a closed volume (9). Said container is characterised in that it comprises at least an orifice (7, 8) provided with closing means and arranged in the outer wall (3), said orifice (7) being designed to introduce or extract a fluid either thermally conductive, or thermally insulating, in the closed volume (9) and to enable simultaneously the movement of air. The invention is applicable in particular to heat insulation of beverages to be consumed hot or cold.

The present invention relates to a thermally insulated container, particularly a bottle, flask, can or the like, designed to receive a product, preferably a food product, for example a beverage.

### TECHNICAL FIELD OF THE INVENTION

The principle of a double wall for limiting heat exchanges between the interior and the exterior of a container—or vice versa—has been known for quite some time. The Dewar's flask, which comprises two walls that are silvered on the inside, between which a vacuum is produced, eliminates any possibility of a thermal transfer by conduction, convection or radiation. This type of container, invented by the nineteenth-century English chemist and physician for whom it is named, is the ancestor of all the thermally insulated containers known today as “thermos bottles.”

However, thermoses are fragile, and therefore it is common to replace the existing vacuum between the two walls with a material of low heat conductivity, in order to improve the strength of the double wall.

In this respect, as shown in particular by U.S. Pat. No. 2,215,532 granted on Sep. 24, 1940 in the name of E. Richardson, the use of a thermally insulating fluid is not novel. The method and device described also provide a solution to the problem of reheating an insulated container, which consists of precisely controlling the convection movements of the fluid inside the wall.

The issue of allowing thermal exchanges between the environment and the container's interior and of insulating the latter as needed can be important, for example in the sale of beverages that must preferably be consumed hot or cold, each at a so-called ideal temperature. This requires efficiently heating—or cooling—the beverage to said ideal consumption temperature inside its container, then maintaining it at this desired ideal temperature until the moment it is consumed, said beverage then being insulated or, in other words, the container then no longer being subject to a thermal transfer from its environment, in order to maintain the beverage at the ideal consumption temperature.

To this end, the thermal properties of the wall of the container can be adapted to various conditions of use through an appropriate choice of insulating fluid, as described in British patent 506,634 filed on Aug. 28, 1937 in the name of G. Zondervan. This patent concerns, more particularly, a vessel for transporting milk, whose double wall is in the form of a spiral tube. The milk is heat treated prior to shipping by means of hot water circulating through the tube. The water is then drained and replaced with air; under these conditions, the temperature of the milk remains above 55° C. for 6 hours.

But the container described in this document is large and structurally complex and has little in common with bottles, flasks, cans or the like intended for individual use, other than the thermal insulation of its walls.

On the other hand, the container described in U.S. Pat. No. 5,555,746 granted on Sep. 17, 1996 in the name of P. Thompson, which can contain standard plastic beverage bottles and keep them cold, seems designed for a more commonplace use. Its production method includes the filling of the double wall with either a refrigerant liquid or a thermally conductive liquid such as water. The base of the container can also contain an element with a high thermal capacity, cooled in advance.

In fact, even though during production there is the possibility of a choice between conductive walls and insulating walls, it appears that the receptacle produced differs from the known types only in the details.

It is therefore clear from the prior art as described in the above-mentioned documents that there are known double-wall receptacles, wherein the chamber or space between walls contains a fluid, which have two states, insulating and conductive, but that to date, there is no existing device that precisely meets the stated needs.

### GENERAL DESCRIPTION OF THE INVENTION

The present invention concerns a thermally insulated container, preferably a bottle, flask, can or the like, designed to directly receive a product, for example a food product and preferably a beverage, introduced or extracted, by means of an opening closed by a cap, into or from an interior delimited by an inner wall, said container also comprising an outer wall which, with the inner wall, delimits a closed chamber. More precisely, the subject of the invention is a container of this type comprising at least one orifice provided with closing means and formed in the outer wall. This orifice is designed for introducing or extracting a thermally conductive or thermally insulating fluid into or from the chamber delimited by the double wall, and for allowing the movement of air.

Advantageously, the container of the aforementioned type comprises two orifices provided with closing means and formed in the outer wall, the first orifice being designed for introducing or extracting a thermally conductive or thermally insulating fluid into or from the chamber, and the second orifice being designed to allow the movement of the air.

Preferably, in both of the aforementioned variants, the single orifice or the two orifices are formed in the vicinity of the opening, which can advantageously be provided with a neck at the end.

The thermally insulating fluid can be either a liquid or a gas.

Preferably, the thermally insulated container according to the invention is to be used only once.

Advantageously, the double wall of this container is made of plastic or aluminum, or any other material compatible with the product to be thermally insulated.

### BRIEF DESCRIPTION OF THE DRAWING

FIG. 1 is a schematic sectional view of the thermally insulated container according to the invention.

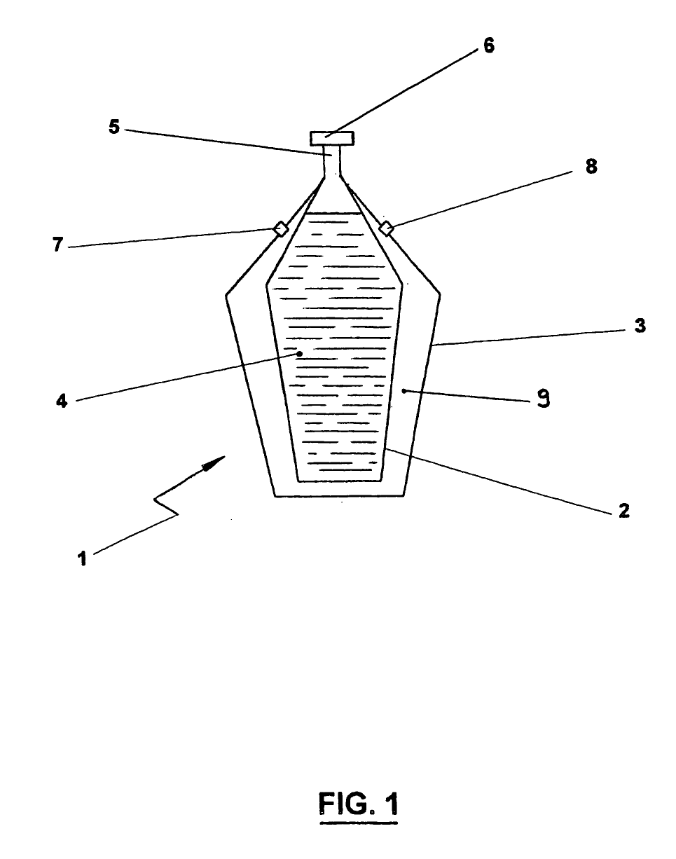

### DESCRIPTION OF A PREFERRED EMBODIMENT OF THE INVENTION

The present invention consists in a container (1) with a double wall, each of said walls (2, 3) being impermeable. The inner wall (2) delimits a closed interior (4) designed to receive a product, preferably a food product, which throughout the description below will be defined, by way of example, as a “beverage.” The top part of the wall (2), which is either flat in the case where the container is a type of “can,” or neck-shaped—as shown for example in the drawing—in the case where the container is a type of “bottle” or “flask,” comprises an opening (5) that is closed by a cap (6). The outer wall (3) comprises an orifice, and preferably two orifices (7, 8) that are advantageously near the opening (5), in this case the neck, and that in any case are provided with closures. When there are two orifices, one of them, for example the orifice (7), makes it possible to introduce into a chamber (9), also closed, which constitutes the space inside the double wall (2, 3), a thermally conductive fluid. The second orifice (8) in this case allows the evacuation of the air that until then has been contained in the chamber (9). In the variant with only one orifice, for example the orifice (7), the latter is wide enough and has a size such that it allows the introduction into the chamber (9) of the thermally conductive fluid and the simultaneous evacuation of the air contained until then in said chamber. The single orifice, or in the variant the two orifices (7, 8) are closed after this operation.

The chamber (9) of the double wall (2, 3) thus filled with conductive fluid, has a high thermal conductibility, which encourages thermal transfers between the interior (4) and the environment. The beverage can then be easily reheated, or cooled, to the desired temperature, which is equal or very close to its ideal consumption temperature, the desired temperature in this case being that of the environment of the container.

Then, at any time, on condition that the container (1) has been stored in a place where the temperature has been maintained at a value equal or very close to the appropriate consumption temperature of the beverage, the thermally conductive fluid is evacuated by means of the single orifice or one of the two orifices (7), and this fluid is replaced with a thermally insulating fluid. The single orifice, if it is appropriately sized, or the other orifice (8) in the variant with two orifices, then allows the movement of air.

Under these conditions, heat exchanges between the beverage and the outside are subsequently limited, and said beverage retains its optimal temperature.

The thermally conductive fluid can be either a liquid or a conductive gas at an ordinary temperature, which is then replaced with air.

It is therefore quite clear in the second case that the conductive gas must be non-toxic and nonflammable. If the thermally conductive fluid is a liquid, the latter can either be water, or an additional volume of the beverage insulated inside the interior (4), for example coffee or soup in the case of a beverage to be consumed hot, or beer, coffee, soda or fruit juice in the case of a beverage to be consumed cold.

The containers having the aforementioned characteristics are either containers that are thrown away after the beverage they contain has been extracted from the interior (4) through the opening (5) and consumed, or reusable containers that are collected after use, cleaned, and then refilled with a product that is subjected to the successive treatments described above, i.e. heated or cooled to its desired consumption temperature, then maintained at this temperature until, at the chosen moment, the thermally conductive fluid, which in a certain environment has allowed for the appropriate heating or cooling of the product and the subsequent maintenance of its temperature, is evacuated and replaced with thermally insulating air.

Advantageously, the two walls (2, 3) of these “mineral water bottle,” “soda bottle,” or “beer can” type containers are made of aluminum or plastic, or any other material compatible with the product to be thermally insulated.

The following is a nonlimiting list of examples of products that can be contained in a container according to the invention:

water, which may or may not be mineral water and may or may not be carbonated, milk and other liquid or solid milk-based foods, tea-, coffee- or chocolate-based beverages, soups and broths, sodas, fruit juices, beer, carbonated soft beverages, wine, alcohol such as vodka, in terms of food products,

blood, in terms of a non-food liquid,

organs for transplant.

It is clear that the invention is not limited to just the above embodiment given as an example; on the contrary, it encompasses all of the possible variants of embodiment.

1. Thermally insulated container (1), preferably a “bottle,” “flask,” “can,” or the like, designed to directly receive a product, preferably a food product, introduced or extracted, by means of an opening (5) closed by a cap (6), into or from an interior (4) delimited by an inner wall (2), said container also comprising an outer wall (3), which with the inner wall delimits a closed chamber (9), and being characterized in that it comprises at least one orifice (7, 8) provided with closing means and formed in said external wall (3), said orifice (7) being designed for introducing or extracting a thermally conductive or thermally insulating fluid into or from the chamber (9) and for simultaneously allowing the movement of air.

2. Thermally insulated container (1) according to claim 1, characterized in that it comprises two orifices (7, 8) provided with closing means and formed in the outer wall (3), said first orifice (7) being designed for introducing or extracting a thermally conductive or thermally insulating fluid into or from the chamber (9), and said second opening (8) being designed to allow the movement of air.

3. Thermally insulated container (1) according to either of claims 1 and 2, characterized in that the single orifice or the two orifices (7, 8) are formed near its opening (5).

4. Thermally insulated container (1) according to any of claims 1 through 3, characterized in that the thermally conductive fluid is either a liquid or a gas.

5. Thermally insulated container (1) according to any of claims 1 through 4, characterized in that the double wall (2, 3) is made of plastic or aluminum or any other material compatible with the product to be thermally insulated.

6. Thermally insulated container (1) according to any of claims 1 through 5, characterized in that said container (1) is to be used only once.

7. Thermally insulated container (1) according to any of claims 1 through 5, characterized in that said container (1) is reusable.

8. Thermally insulated container (1) according to any of claims 1 through 7, characterized in that the product contained in the interior (4) and the thermally conductive fluid are identical.
